(19) United States
(12) Patent Application Publication
(10) Pub. No.: US 2025/0179874 A1
(43) Pub. Date: Jun. 5, 2025

(54) MONITORED LADDER SYSTEM

(71) Applicant: Trinity Central Maintenance, LLC, Dallas, TX (US)

(72) Inventor: Philip Blackstone, Sunnyvale, TX (US)

(21) Appl. No.: 18/529,706

(22) Filed: Dec. 5, 2023

(51) Int. Cl. E06C 7/00

(52) U.S. Cl. CPC E06C 7/003

(57) ABSTRACT

According to some embodiments, a ladder monitoring system for monitoring one or more conditions associated with a ladder comprises a sensor controller and one or more sensors coupled to the ladder and communicably coupled to the sensor controller. The sensor controller is configured to: receive data from the one or more sensors; based on the data received from the one or more sensors, determine a condition associated with the ladder; and provide an indication of the condition associated with the ladder.

### TECHNICAL FIELD OF THE INVENTION

This disclosure relates generally to environmental monitoring, and more particularly to a monitoring system for a ladder.

### BACKGROUND

Ladders are commonly used to enter potentially hazardous locations. Thus, there is a benefit for the ladder user and others to know the conditions of the space accessed by the ladder and a status of the potential occupant. Tracking these states has historically been done with in-person observation or using a log. These methods are local and susceptible to human error.

### SUMMARY

As described above, ladders may be used to enter potentially hazardous locations. Particular embodiments include a monitoring system for monitoring the environment in which the ladder is used and when and how the ladder is accessed.

According to some embodiments, a ladder monitoring system for monitoring one or more conditions associated with a ladder comprises a sensor controller and one or more sensors coupled to the ladder and communicably coupled to the sensor controller. The sensor controller is configured to: receive data from the one or more sensors; based on the data received from the one or more sensors, determine a condition associated with the ladder; and provide an indication of the condition associated with the ladder.

In particular embodiments, the sensor controller is communicably coupled to a remote monitoring system and the sensor controller provides an indication of the condition associated with the ladder by transmitting an indication to the remote monitoring system.

In particular embodiments, the condition associated with the ladder comprises a condition of an environment proximate the ladder, an indication of a presence of a user on the ladder, a number of ascents or descents associated with the ladder, etc.

In particular embodiments, the ladder monitoring system further comprises a visual condition indicator coupled to the sensor controller and/or an audio condition indicator coupled to the sensor controller.

In particular embodiments, the one or more sensors comprise at least one usage detection sensor (e.g., a pressure gauge, a strain gauge, a load cell, an X-Ray detector, an infrared (IR) detector, a motion sensor, etc.) and at least one environment detection sensor (e.g., a gas sensor, a noise sensor, a light sensor, a water sensor, a pressure sensor, a heat sensor, an electromagnetic energy sensor, a radiation sensor, an accelerometer; a position sensor, etc.) and the determined condition is based on the data received from the at least one usage detection sensor and the at least one environment detection sensor.

Certain embodiments of the ladder monitoring system may provide one or more technical advantages. For example, particular embodiments may deter a person from using a ladder to enter hazardous environments. Particular embodiments may remotely alert a monitoring station and/or summon assistance should a person enter the hazardous environment. Accordingly, particular embodiments reduce the likelihood of injury and/or reduce the severity of a potential injury.

### BRIEF DESCRIPTION OF THE DRAWINGS

For a more complete understanding of the present disclosure, reference is now made to the following description, taken in conjunction with the accompanying drawings, in which:

FIG. 1 is a perspective view of a ladder monitoring system, according to particular embodiments;

FIG. 2 is block diagram illustrating a ladder monitoring system, according to particular embodiments;

FIG. 3 is a block diagram illustrating components of a ladder monitoring system, according to particular embodiment; and

FIG. 4 is a flowchart describing an example method for use with a ladder monitoring system.

### DETAILED DESCRIPTION

As described above, ladders may be used to enter potentially hazardous locations. Particular embodiments include a monitoring system for monitoring the environment in which the ladder is used and when and how the ladder is accessed.

In particular embodiments, a ladder that is fitted with instrumentation that may be monitored. For example, the ladder may be fitted with gauges that detect a person using the ladder. By using multiple sensors, the ladder monitoring system may detect ascents and/or descents. Some embodiments may use strain gauges as well as load cells, X-ray, infrared (IR), or other sensors.

In some embodiments the gauges are coupled to a controller. The controller may keep a running tally of ascents and descents. The controller may display or otherwise broadcast the number of personnel that are in the space accessed by the ladder.

Additional monitors may be added to the ladder to sense the conditions of the space. The monitors may measure conditions of concern, such as gas levels, noise, light, pressure, heat, electromagnetic energy, or others. The monitors may be coupled to the controller, either directly or indirectly. The controller may be locally reviewed and may be set to identify specific conditions and send an alert.

For example, in one embodiment, an orange light turns on if an unsafe condition exists and a red light may flash and a siren may sound if an unsafe condition exists and someone attempts to use the ladder to ascend or descend. The controller may be connected to a network, such as the Internet, and thus be monitored remotely. In these embodiments, in addition to the local alerts, the controller may notify of a potential issue via short message service (SMS), email, dashboard, or other communications. The alerts may trigger other actions, such as prompting observation by camera or summoning appropriate personnel.

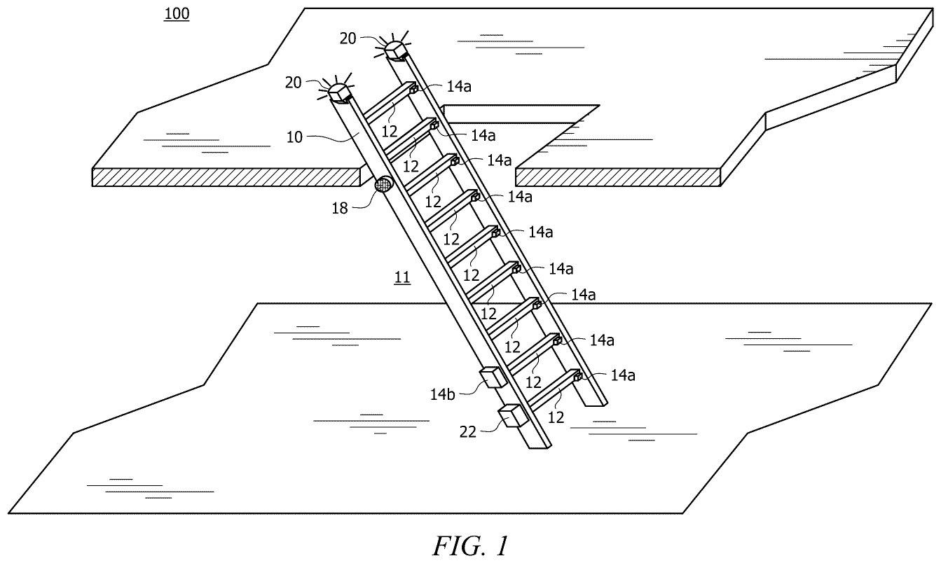

Accordingly, particular embodiments described herein may deter a person from using a ladder to enter hazardous environments. Particular embodiments may remotely alert a monitoring station and/or summon assistance should a person enter the hazardous environment. Accordingly, particular embodiments reduce the likelihood of injury and/or reduce the severity of a potential injury. Embodiments of the present disclosure and its advantages are best understood by referring to FIGS. 1 through 4 of the drawings, like numerals being used for like and corresponding parts of the various drawings.

It is to be understood the present invention is not limited to particular devices or methods, which may vary. It is also to be understood that the terminology used herein is for the purpose of describing particular embodiments only and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

FIG. 1 is a perspective view of a ladder monitoring system, according to particular embodiments. Ladder monitoring system 100 monitors one or more conditions associated with ladder 10. Ladder 10 may be used for descending into area 11 or ascending from area 11.

Ladder 10 comprises a plurality of rungs 12, one or more sensors 14 coupled to ladder 10, and sensor controller 22. Sensors 14 are communicably coupled to sensor controller 22.

Sensor controller 22 is configured to receive data from one or more sensors 14, and based on the data received from one or more sensors 14, determine a condition associated with the ladder. Sensor controller 22 may provide an indication of the condition associated with the ladder.

For example, in some embodiments ladder 10 may comprise one or more audio condition indicators 18 and/or one or more visual condition indicators 20. Audio condition indicator 18 may comprise an alarm, bell, etc. Audio condition indicator 18 may comprise a speaker for announcing a condition, announcing a warning, providing instructions, etc. Visual condition indicator 20 may comprise a light for indicating a condition associated with the ladder. Visual condition indicator 20 may indicate a condition via its status (e.g., on/off), or via a color coded warning system (e.g., green/yellow/orange/red), etc.

Ladder 10 may comprise a variety of sensors 14. As used herein, sensor 14 may also be referred to as a monitor, gauge, detector, etc.

In some embodiments, ladder 10 comprises one or more usage detection sensors, such as usage detection sensors 14a. Usage detection sensors 14a are configured to detect a person using the ladder. Usage detection sensor 14a may comprise one or more of a pressure gauge, strain gauge, load cell, X-Ray detector, infrared (IR) detector, motion sensor, or other sensors.

Although usage detection sensors 14a are illustrated as coupled to each rung of ladder 10, other embodiments include a variety of coupling locations and different quantities of usage detection sensors 14a. In some embodiments, usage detection sensors 14a may be coupled to the exterior of rungs 12 on the functional surface to, e.g., detect footsteps on rungs 12 (e.g., pressure gauge). In some embodiments, the usage detection sensors 14a may be integrated with rungs 12 or inside rungs 12 (e.g., strain gauge). In some embodiments usage detection sensors 14a may be coupled to ladder 10 between rungs 12 to detect motion (e.g., IR sensor).

In some embodiments, a single usage detection sensor 14a may be coupled to the top or bottom of ladder 10 to detect usage. In some embodiments, the first N number of rungs 12 may include usage detection sensors 14a. In some embodiments, every N number of rungs 12 may include usage detection sensors 14a.

In some embodiments, ladder 10 comprises one or more environment detection sensors, such as environment detection sensor 14b. Environment detection sensors 14b detects a condition associated with an environment proximate ladder 10. For example, ladder 10 may be used in an environment where a gas leak may be possible or where gases may settle. Environment detection sensor 14b may measure a gas level in the environment proximate the bottom of ladder 10. In some embodiments, environment detection sensor 14b may comprise any suitable type of sensor, such as noise, light, water, pressure, heat, electromagnetic energy, radioactivity, etc.

In some embodiments, environment detection sensor 14b may comprise a positioning sensor that detects a position of ladder 10. For example, environment detection sensor 14b may comprise an accelerometer to detect movement of ladder 10. For example, the accelerometer may detect if the ladder becomes unstable or is removed from its intended location. Environment detection sensor 14b may comprise a global positioning system (GPS) sensor, or any other suitable positioning sensor, such as Wi-Fi or cellular enabled positioning systems.

In some embodiments, environment detection sensor 14b may comprise a microphone and/or camera for monitoring activity proximate ladder 10, such as when an alarm condition is detected. Such information may help rescue personnel determine an appropriate response.

Although a single environment detection sensor 14b is illustrated coupled to ladder 10 at a particular location, particular embodiments may include any number of environment detection sensors 14b coupled at any suitable location(s).

Sensor controller 22 determines a condition associated with the ladder based on the data received from one or more sensors 14. For example, sensor controller 22 may determine a high gas level present proximate ladder 10 based on data received from environment detection sensor 14b. Based on the high gas level, sensor controller 22 may provide an indication of the high gas level via visual condition indicator 20. For example, sensor controller 22 may turn visual condition indicator 20 orange to indicate the dangerous gas level to a potential user of ladder 10.

Sensor controller 22 may determine a user is present on the ladder based on data received from usage detection sensor 14a. If sensor controller 22 has also previously determined a high gas level, then sensor controller 22 may sound audio condition indicator 18 and/or flash visual condition indicator 20 or turn visual condition indicator 20 from orange to red to warn the potential user of the potentially dangerous condition.

Sensor controller 22 may determine a number of users have used the ladder to descend into area 11. Upon determining a high gas level and because people are present in area 11, sensor controller may sound audio condition indicator 18 and/or activate visual condition indicator 20 to warn the people in area 11 of the newly discovered high gas level.

Sensor controller 22 may determine a dangerous condition has subsided and may deactivate visual condition indicator 20 and/or audio condition indicator 18.

Sensor controller 22 may comprise a configuration interface for receiving configuration of threshold levels, sensor activation/deactivation, etc. In this way, one ladder monitoring system may be configured or reconfigured for monitoring in different environments.

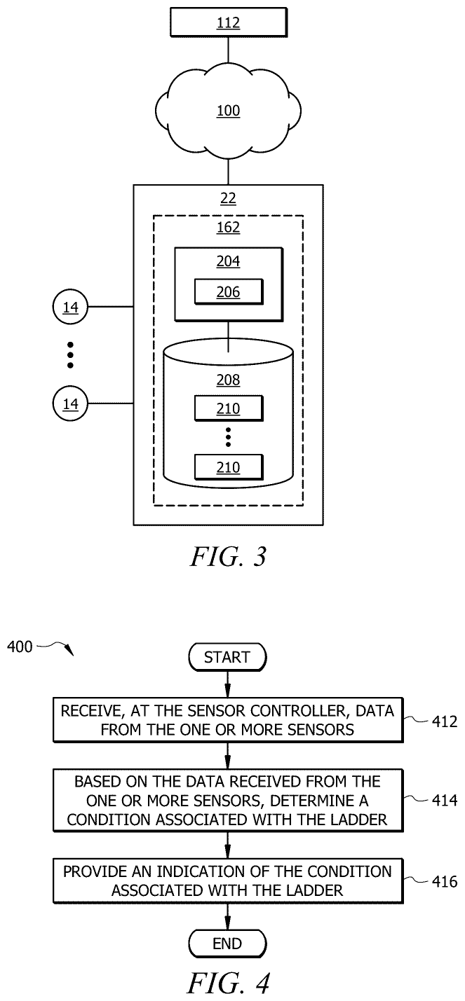

The components of sensor controller 22 are described in more detail with respect to FIG. 3.

In particular embodiments, ladder 10 comprises a power source (not illustrated) for sensor controller 22 and sensors 14. The power source may comprise one or more batteries, solar panels, or a hardwired power source.

Ladder 10 may be mobile, or may be permanently or semi-permanently fixed in place, according to particular embodiments.

The previous examples are only a few examples, and particular embodiments may include any combination of sensors and condition indicators described herein.

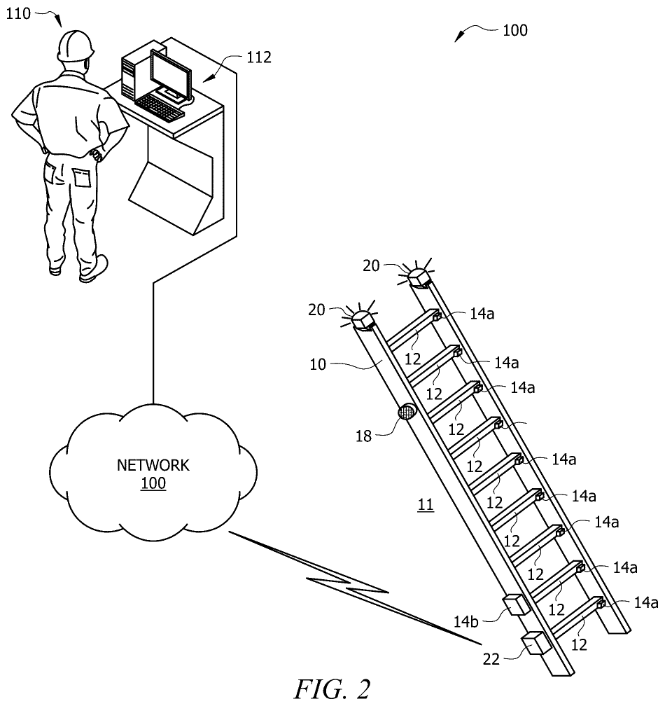

FIG. 2 is block diagram illustrating a ladder monitoring system, according to particular embodiments. In the illustrated example, ladder monitoring system further comprises remote monitoring system 112 communicably coupled to ladder 10 via network 100.

Sensor controller 22 may include data transmission equipment to facilitate transmission of data collected by the sensor controller to a remote location, such as remote monitoring system 112. In some embodiments, the data transmission equipment is provided with cellular connection using fourth generation (4G) or fifth generation (5G) communications.

Remote monitoring system 112 may be monitored by monitoring personnel 110. Monitoring personnel 110 may be a third party monitoring service, may be an emergency response dispatcher, an employee of the owner of the ladder monitoring system, or any other suitable monitoring entity.

In response to receiving the indication of the condition associated with the ladder, remote monitoring system 112 and/or monitoring personnel 110 may take various actions. For example, upon receiving an indication of a dangerous gas level associated with the ladder, remote monitoring system 112 and/or monitoring personnel 110 may notify emergency personnel that a rescue situation exists. For example, based on the number of ascents and/or descents, the remote monitoring may determine how many people have used the ladder and thus how many people may be in danger. This may assist rescue personnel to determine whether all potential victims have been rescued.

In particular embodiments, monitoring personnel 110 may provide real time instructions remotely via audio condition indicator 18 (i.e., audio condition indicator comprises a speaker).

Other actions include increased monitoring, such as activating cameras near the ladder, dispatching additional assistance or alerting personnel in different offices or locations.

FIG. 3 is a block diagram illustrating components of a ladder monitoring system, according to particular embodiment. Sensor controller 22 is communicably coupled to one or more sensors 14 (e.g., sensors 14a and 14b described with respect to FIG. 1). The coupling may be wired or wireless. In some embodiments sensors 14 are wirelessly coupled to sensor controller 22 via Bluetooth, Wi-Fi, or any other suitable communication protocol. Sensor controller 22 receives data from sensors 14 according to any of the embodiments and examples described above. Sensor controller 22 is communicably coupled to remote monitoring system 112 via network 100. In some embodiments, sensor controller 22 comprises an Internet-of-things (IoT) device.

The sensor controller includes a processor that executes non-transitory program instructions. Sensor controller 22 comprises processing circuitry 162. Processing circuitry 162 comprises memory 208 operable to store received data 210 and instructions 206, and one or more processors 204 coupled to memory 208. One or more processors 204 may be implemented as one or more central processing unit (CPU) chips, logic units, cores (e.g., a multi-core processor), field-programmable gate array (FPGAs), application specific integrated circuits (ASICs), or digital signal processors (DSPs). The one or more processors are configured to implement various instructions 206 to monitor and control sensors 14 and communicate with remote monitoring system 112, and may be implemented in hardware and/or software.

Memory 208 comprises one or more disks, tape drives, or solid-state drives, and may be used as an over-flow data storage device, to store programs when such programs are selected for execution, and to store instructions and data that are read during program execution, such as instructions and logic rules. Memory 208 may be volatile or non-volatile and may comprise read only memory (ROM), random access memory (RAM), ternary content-addressable memory (TCAM), dynamic RAM (DRAM), and/or static RAM (SRAM). Memory 208 may comprise cloud storage. Memory 208 is operable to store, for example, measurements and configuration 210.

In some embodiments, sensor controller 22 comprises wireless communication circuitry for communication over a wireless network. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards, including Internet-of-Things (IoT), etc.; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 100 comprises a plurality of network nodes configured to communicate data between sensor controller 22 and remote monitoring system 112. Examples of network nodes include, but are not limited to, routers, switches, modems, web clients, and web servers. Network 100 comprises any suitable type of wireless and/or wired network including, but not limited to, all or a portion of the Internet, the public switched telephone network, a cellular network, and/or a satellite network. Network 100 is configured to support any suitable communication protocols as would be appreciated by one of ordinary skill in the art upon viewing this disclosure.

FIG. 4 is a flowchart describing an example method for use with a ladder monitoring system. The ladder monitoring system comprises a sensor controller and one or more sensors coupled to the ladder and communicably coupled to the sensor controller. In particular embodiments, one or more steps of FIG. 4 may be performed by ladder monitoring system 100 described with respect to FIGS. 1-3.

The method begins at step 412, where the sensor controller receives data from the one or more sensors. The sensor controller may receive data according to any of the embodiments and examples described herein.

In particular embodiments, the one or more sensors comprise at least one usage detection sensor (e.g., a pressure gauge, a strain gauge, a load cell, an X-Ray detector, an infrared (IR) detector, a motion sensor, etc.) and at least one environment detection sensor (e.g., a gas sensor, a noise sensor, a light sensor, a water sensor, a pressure sensor, a heat sensor, an electromagnetic energy sensor, a radiation sensor, an accelerometer; a position sensor, etc.).

Based on the data received from the one or more sensors, the method continues to step 414, where the sensor controller determines a condition associated with the ladder. In particular embodiments, the condition associated with the ladder comprises a condition of an environment proximate the ladder (e.g. an alert condition), an indication of a presence of a user on the ladder, a number of ascents or descents associated with the ladder, etc. In some embodiments, the condition associated with the ladder comprises any of the conditions described with respect to the embodiments and examples described herein.

At step 416, the sensor controller provides an indication of the condition associated with the ladder. For example, sensor controller 22 may activate visual condition indicator 20 and/or audio condition indicator coupled to sensor controller 22. In some embodiments, sensor controller 22 may transmit the indication to remote monitoring system 112.

Modifications, additions, or omissions may be made to method 400 of FIG. 4. Additionally, one or more steps in the method of FIG. 4 may be performed in parallel or in any suitable order.

Although the present disclosure includes several embodiments, a myriad of changes, variations, alterations, transformations, and modifications may be suggested to one skilled in the art, and it is intended that the present disclosure encompass such changes, variations, alterations, transformations, and modifications as falling within the scope of this disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

1. A ladder monitoring system for monitoring one or more conditions associated with a ladder, comprising:
a sensor controller;
one or more sensors coupled to the ladder and communicably coupled to the sensor controller;
the sensor controller configured to:
receive data from the one or more sensors;
based on the data received from the one or more sensors, determine a condition associated with the ladder; and
provide an indication of the condition associated with the ladder.

2. The ladder monitoring system of claim 1, wherein the sensor controller is communicably coupled to a remote monitoring system and the sensor controller provides an indication of the condition associated with the ladder by transmitting an indication to the remote monitoring system.

3. The ladder monitoring system of claim 1, wherein the condition associated with the ladder comprises a condition of an environment proximate the ladder.

4. The ladder monitoring system of claim 1, wherein the condition associated with the ladder comprises an indication of a presence of a user on the ladder.

5. The ladder monitoring system of claim 1, wherein the condition associated with the ladder comprises a number of ascents or descents associated with the ladder.

6. The ladder monitoring system of claim 1, further comprising a visual condition indicator coupled to the sensor controller.

7. The ladder monitoring system of claim 1, further comprising an audio condition indicator coupled to the sensor controller.

8. The ladder monitoring system of claim 1, wherein the one or more sensors comprise at least one usage detection sensor and at least one environment detection sensor and the determined condition is based on the data received from the at least one usage detection sensor and the at least one environment detection sensor.

9. The ladder monitoring system of claim 8, wherein the at least one usage detection sensor comprises any one of:
a pressure gauge;
a strain gauge;
a load cell;
an X-Ray detector;
an infrared (IR) detector; and
a motion sensor.

10. The ladder monitoring system of claim 8, wherein the at least one environment detection sensor comprises any one of:
a gas sensor;
a noise sensor;
a light sensor;
a water sensor;
a pressure sensor;
a heat sensor;
an electromagnetic energy sensor;
a radiation sensor;
an accelerometer; and
a position sensor.

11. The ladder monitoring system of claim 1, wherein the sensor controller comprises an Internet-of-Things (IoT) device.

12. A method performed by a ladder monitoring system for monitoring one or more conditions associated with a ladder, the ladder monitoring system comprising a sensor controller and one or more sensors coupled to the ladder and communicably coupled to the sensor controller, the method comprising:
receiving, at the sensor controller, data from the one or more sensors;
based on the data received from the one or more sensors, determining a condition associated with the ladder; and
providing an indication of the condition associated with the ladder.

13. The method of claim 12, wherein providing the indication of the condition associated with the ladder comprises transmitting the indication to a remote monitoring system.

14. The method of claim 12, wherein the condition associated with the ladder comprises a condition of an environment proximate the ladder.

15. The method of claim 12, wherein the condition associated with the ladder comprises an indication of a presence of a user on the ladder.

16. The method of claim 12, wherein the condition associated with the ladder comprises a number of ascents or descents associated with the ladder.

17. The method of claim 12, wherein providing the indication of the condition associated with the ladder comprises activating a visual condition indicator coupled to the sensor controller.

18. The method of claim 12, wherein providing the indication of the condition associated with the ladder comprises activating an audio condition indicator coupled to the sensor controller.

19. The method of claim 12, wherein the one or more sensors comprise at least one usage detection sensor and at least one environment detection sensor and the determined condition is based on the data received from the at least one usage detection sensor and the at least one environment detection sensor.

20. A ladder monitoring system for monitoring one or more conditions associated with a ladder, comprising:
a sensor controller;
one or more sensors coupled to the ladder and communicably coupled to the sensor controller;
a remote monitoring system communicably coupled to the sensor controller;
the sensor controller configured to:
receive data from the one or more sensors;
based on the data received from the one or more sensors, determine a condition associated with the ladder; and
provide an indication of the condition associated with the ladder to the remote monitoring system.
